(19) United States
(12) Patent Application Publication
(10) Pub. No.: US 2018/0335942 A1
(43) Pub. Date: Nov. 22, 2018

(54) DATA READING METHOD, MEMORY CONTROL CIRCUIT UNIT AND MEMORY STORAGE DEVICE

(71) Applicant: PHISON ELECTRONICS CORP., Miaoli (TW)

(72) Inventor: Chih-Kang Yeh, Kinmen County (TW)

(73) Assignee: PHISON ELECTRONICS CORP., Miaoli (TW)

(21) Appl. No.: 15/648,459

(22) Filed: Jul. 13, 2017

(30) Foreign Application Priority Data
May 19, 2017 (TW) 106116782

(51) Int. Cl. G06F 3/06

(52) U.S. Cl. CPC G06F 3/061; G06F 3/0659; G06F 3/0679

(57) ABSTRACT

A data reading method for a rewritable non-volatile memory module is provided. The method includes: receiving a read command instructing reading data from a plurality of logical addresses; selecting a plurality of logical addresses meeting a preset condition among the logical addresses, wherein the selected logical addresses include a first logical address mapping to a first physical programming unit and a second logical address mapping to a second physical programming unit, wherein the preset condition includes that the first physical programming unit belongs to a first plane, the second physical programming unit belongs to a second plane, the first plane and the second plane are different and belong to a same die, and a first address index value of the first physical programming unit is different from a second address index value of the second physical programming unit; and reading data belonging to the selected logical addresses in parallel.

### CROSS-REFERENCE TO RELATED APPLICATION

This application claims the priority benefit of Taiwan application serial no. 106116782, filed on May 19, 2017. The entirety of the above-mentioned patent application is hereby incorporated by reference herein and made a part of this specification.

### BACKGROUND

### Technical Field

The invention relates to a data reading method, and more particularly, to a data reading method for a rewritable non-volatile memory module, and a memory control circuit unit and a memory storage device using the same.

### Description of Related Art

The rapid growth in the popularity of digital cameras, cellular phones, and MP3 players in recent years has brought about the escalated demand for storage media by consumers. A rewritable non-volatile memory module is highly adaptable to be disposed in portable electronic products as the storage medium for the portable electronic products due to its data non-volatility, low power consumption, small volume, non-mechanical structure and high read/write speed.

In general, in a storage device disposed with the rewritable non-volatile memory module having multiple dies or multiple planes, a memory controller is capable of accelerating a data access speed by using a multi-plane accessing operation. For example, the memory controller can simultaneously give read commands to multiple physical programming units belonging to different dies or different planes by a multi-plane reading operation, so as to simultaneously read data stored in said physical programming units.

However, traditionally, the memory controller can simultaneously read the data stored in the physical programming units belonging to the different planes only when a sequential read is executed. In other words, the multi-plane reading operation can only be executed if the physical programming units to be read are at the same location in their respective plane. Based on such restriction, the memory controller is unable to accelerate a reading speed of random read by using the multi-plane reading operation. Consequently, the result of the multi-plane reading operation is rather disappointing.

Nothing herein should be construed as an admission of knowledge in the prior art of any portion of the present invention. Furthermore, citation or identification of any document in this application is not an admission that such document is available as prior art to the present invention, or that any reference forms a part of the common general knowledge in the art.

### SUMMARY

The invention is directed to a data reading method, a memory control circuit unit and a memory storage device, which are capable of accelerating a reading speed of a random reading operation.

An exemplary embodiment of the invention proposes a data reading method for a rewritable non-volatile memory module. The rewritable non-volatile memory module has at least one die, a plurality of planes and a plurality of physical programming units. The data reading method includes receiving at least one read command from a host system, wherein the at least one read command instructs reading data belonging to a plurality of logical addresses. Further, the data reading method also includes selecting a plurality of logical addresses meeting a preset condition among the logical addresses. The selected logical addresses at least include a first logical address and a second logical address. The first logical address maps to a first physical programming unit among the physical programming units. The second logical address maps to a second physical programming unit among the physical programming units. The preset condition includes that the first physical programming unit belongs to a first plane among the planes, the second physical programming unit belongs to a second plane among the planes, the first plane is different from the second plane, the first plane and the second plane belong to a same die among the at least one die, and a first address index value corresponding to the first physical programming unit is different from a second address index value corresponding to the second physical programming unit. Furthermore, the data reading method also includes executing a reading operation corresponding to the selected logical addresses for reading data belonging to the selected logical addresses in parallel.

An exemplary embodiment of the invention provides a memory control circuit unit for controlling a rewritable non-volatile memory module. The rewritable non-volatile memory module has at least one die, a plurality of planes and a plurality of physical programming units. The memory control circuit unit includes a host interface, a memory interface and a memory management circuit. The host interface is configured to couple to a host system. The memory interface is configured to couple to the rewritable non-volatile memory module. The memory management circuit is coupled to the host interface and the memory interface. The memory management circuit is configured to receive at least one read command from the host system, wherein the at least one read command instructs reading data belonging to a plurality of logical addresses. The memory management circuit is further configured to select a plurality of logical addresses meeting a preset condition among the logical addresses. The selected logical addresses at least include a first logical address and a second logical address. The first logical address maps to a first physical programming unit among the physical programming units. The second logical address maps to a second physical programming unit among the physical programming units. The preset condition includes that the first physical programming unit belongs to a first plane among the planes, the second physical programming unit belongs to a second plane among the planes, the first plane is different from the second plane, the first plane and the second plane belong to a same die among the at least one die, and a first address index value corresponding to the first physical programming unit is different from a second address index value corresponding to the second physical programming unit. The memory management circuit is further configured to execute a reading operation corresponding to the selected logical addresses for reading data belonging to the selected logical addresses in parallel.

An exemplary embodiment of the invention provides a memory storage device. The memory storage device includes a connection interface unit, a rewritable non-volatile memory module and a memory control circuit unit. The connection interface unit is configured to couple to a host system. The rewritable non-volatile memory module has a plurality of dies, a plurality of planes and a plurality of physical programming units. The memory control circuit unit is coupled to the connection interface unit and the rewritable non-volatile memory module. The memory control circuit unit is configured to receive at least one read command from the host system, wherein the at least one read command instructs reading data belonging to a plurality of logical addresses. The memory control circuit unit is further configured to select a plurality of logical addresses meeting a preset condition among the logical addresses. The selected logical addresses at least include a first logical address and a second logical address. The first logical address maps to a first physical programming unit among the physical programming units. The second logical address maps to a second physical programming unit among the physical programming units. The preset condition includes that the first physical programming unit belongs to a first plane among the planes, the second physical programming unit belongs to a second plane among the planes, the first plane is different from the second plane, the first plane and the second plane belong to a same die among the at least one die, and a first address index value corresponding to the first physical programming unit is different from a second address index value corresponding to the second physical programming unit. The memory control circuit unit is further configured to execute a reading operation corresponding to the selected logical addresses for reading data belonging to the selected logical addresses in parallel.

Based on the above, according to the invention, multiple physical programming units belonging to different planes of the same die can be selected for executing the multi-plane reading operation, and these physical programming units correspond to different address offset values. Accordingly, the data stored in the physical programming units corresponding to the random reading operation may be simultaneously read by using the multi-plane reading operation. As a result, the data reading speed corresponding to the random reading operation can be accelerated.

To make the above features and advantages of the disclosure more comprehensible, several embodiments accompanied with drawings are described in detail as follows.

It should be understood, however, that this Summary may not contain all of the aspects and embodiments of the present invention, is not meant to be limiting or restrictive in any manner, and that the invention as disclosed herein is and will be understood by those of ordinary skill in the art to encompass obvious improvements and modifications thereto.

### BRIEF DESCRIPTION OF THE DRAWINGS

The accompanying drawings are included to provide a further understanding of the invention, and are incorporated in and constitute a part of this specification. The drawings illustrate embodiments of the invention and, together with the description, serve to explain the principles of the invention.

FIG. 1 is a schematic diagram illustrating a host system, a memory storage device and an input/output (I/O) device according to an exemplary embodiment.

FIG. 2 is a schematic diagram illustrating a host system, a memory storage device and an input/output (I/O) device according to another exemplary embodiment.

FIG. 3 is a schematic diagram illustrating a host system and a memory storage device according to another exemplary embodiment.

FIG. 4A is a schematic block diagram illustrating a memory storage device according to an exemplary embodiment of the invention.

FIG. 4B is a schematic diagram illustrating a rewritable non-volatile memory module coupled to a memory control circuit unit according to an exemplary embodiment.

FIG. 5 is a schematic block diagram illustrating a rewritable non-volatile memory module according to an exemplary embodiment of the invention.

FIG. 6 is a schematic diagram illustrating a memory cell array according to an exemplary embodiment of the invention.

FIG. 7 is a schematic block diagram illustrating a memory control circuit unit according to an exemplary embodiment of the invention.

FIG. 8 is a schematic diagram illustrating management of a rewritable non-volatile memory module according to an exemplary embodiment of the invention.

FIG. 9 is a schematic diagram illustrating physical programming units corresponding to read commands according to an exemplary embodiment of the invention.

FIG. 10 is a flowchart illustrating a data reading method according to an exemplary embodiment of the invention.

### DESCRIPTION OF THE EMBODIMENTS

Reference will now be made in detail to the present preferred embodiments of the invention, examples of which are illustrated in the accompanying drawings. Wherever possible, the same reference numbers are used in the drawings and the description to refer to the same or like parts.

Embodiments of the present invention may comprise any one or more of the novel features described herein, including in the Detailed Description, and/or shown in the drawings. As used herein, “at least one”, “one or more”, and “and/or” are open-ended expressions that are both conjunctive and disjunctive in operation. For example, each of the expressions “at least on of A, B and C”, “at least one of A, B, or C”, “one or more of A, B, and C”, “one or more of A, B, or C” and “A, B, and/or C” means A alone, B alone, C alone, A and B together, A and C together, B and C together, or A, B and C together.

It is to be noted that the term “a” or “an” entity refers to one or more of that entity. As such, the terms “a” (or “an”), “one or more” and “at least one” can be used interchangeably herein.

In general, a memory storage device (a.k.a. a memory storage system) includes a rewritable non-volatile memory module and a controller (a.k.a. a control circuit unit). The memory storage device is usually configured together with a host system so the host system can write data into the memory storage device or read data from the memory storage device.

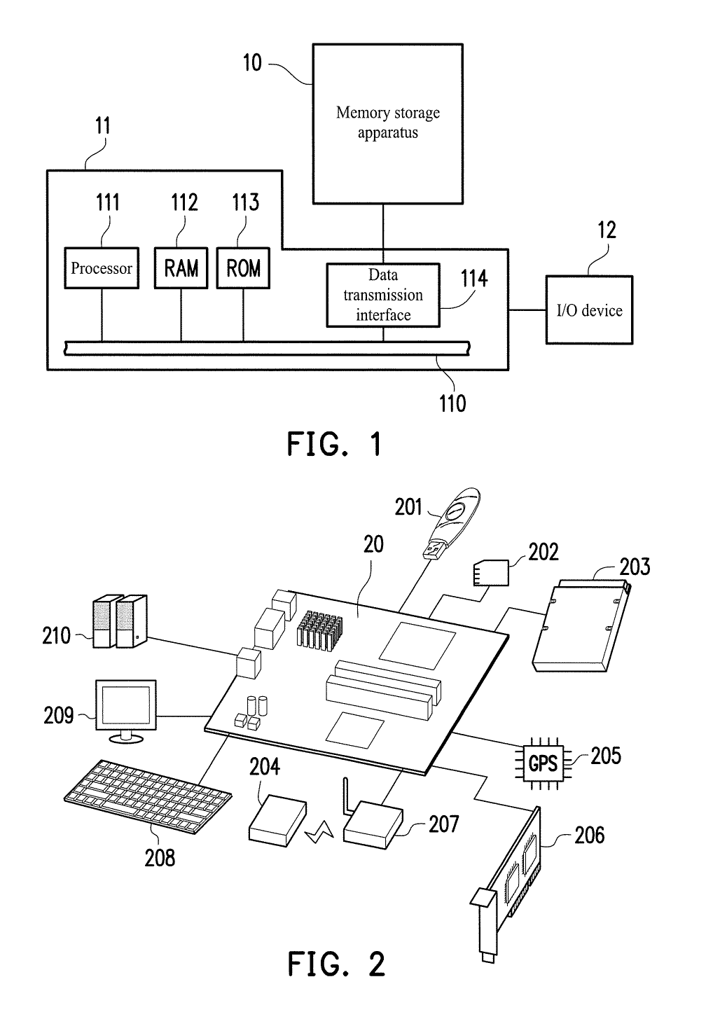

FIG. 1 is a schematic diagram illustrating a host system, a memory storage device and an input/output (I/O) device according to an exemplary embodiment, and FIG. 2 is a schematic diagram illustrating a host system, a memory storage device and an input/output (I/O) device according to another exemplary embodiment.

Referring to FIG. 1 and FIG. 2, a host system 11 generally includes a processor 111, a RAM (random access memory) 112, a ROM (read only memory) 113 and a data transmission interface 114. The processor 111, the RAM 112, the ROM 113 and the data transmission interface 114 are coupled to a system bus 110.

In the present exemplary embodiment, the host system 11 is coupled to a memory storage device 10 through the data transmission interface 114. For example, the host system 11 can write data into the memory storage device 10 or read data from the memory storage device 10 via the data transmission interface 114. Further, the host system 11 is coupled to an I/O device 12 via the system bus 110. For example, the host system 11 can transmit output signals to the I/O device 12 or receive input signals from the I/O device 12 via the system bus 110.

In the present exemplary embodiment, the processor 111, the RAM 112, the ROM 113 and the data transmission interface 114 may be disposed on a main board 20 of the host system 11. The number of the data transmission interface 114 may be one or more. Through the data transmission interface 114, the main board 20 may be coupled to the memory storage device 10 in a wired manner or a wireless manner. The memory storage apparatus 10 may be, for example, a flash drive 201, a memory card 202, a SSD (Solid State Drive) 203 or a wireless memory storage apparatus 204. The wireless memory storage apparatus 204 may be, for example, a memory storage apparatus based on various wireless communication technologies, such as a NFC (Near Field Communication Storage) memory storage apparatus, a WiFi (Wireless Fidelity) memory storage apparatus, a Bluetooth memory storage apparatus, a BLE (Bluetooth low energy) memory storage apparatus (e.g., iBeacon). Further, the main board 20 may also be coupled to various I/O devices including a GPS (Global Positioning System) module 205, a network interface card 206, a wireless transmission device 207, a keyboard 208, a monitor 209 and a speaker 210 through the system bus 110. For example, in an exemplary embodiment, the main board 20 can access the wireless memory storage device 204 via the wireless transmission device 207.

In an exemplary embodiment, aforementioned host system may be any system capable of substantially cooperating with the memory storage device for storing data. Although the host system is illustrated as a computer system in the foregoing exemplary embodiments, nonetheless, FIG. 3 is a schematic diagram illustrating a host system and a memory storage device according to another exemplary embodiment. Referring to FIG. 3, in another exemplary embodiment, a host system 31 may also be a system including a digital camera, a video camera, a communication device, an audio player, a video player or a tablet computer, whereas a memory storage device 30 may be various non-volatile memory storage devices used by the host system 31, such as a SD card 32, a CF card 33 or an embedded storage device 34. The embedded storage device 34 includes various embedded storage devices capable of directly coupling a memory module onto a substrate of the host system, such as an eMMC (embedded MMC) 341 and/or an eMCP (embedded Multi Chip Package) 342.

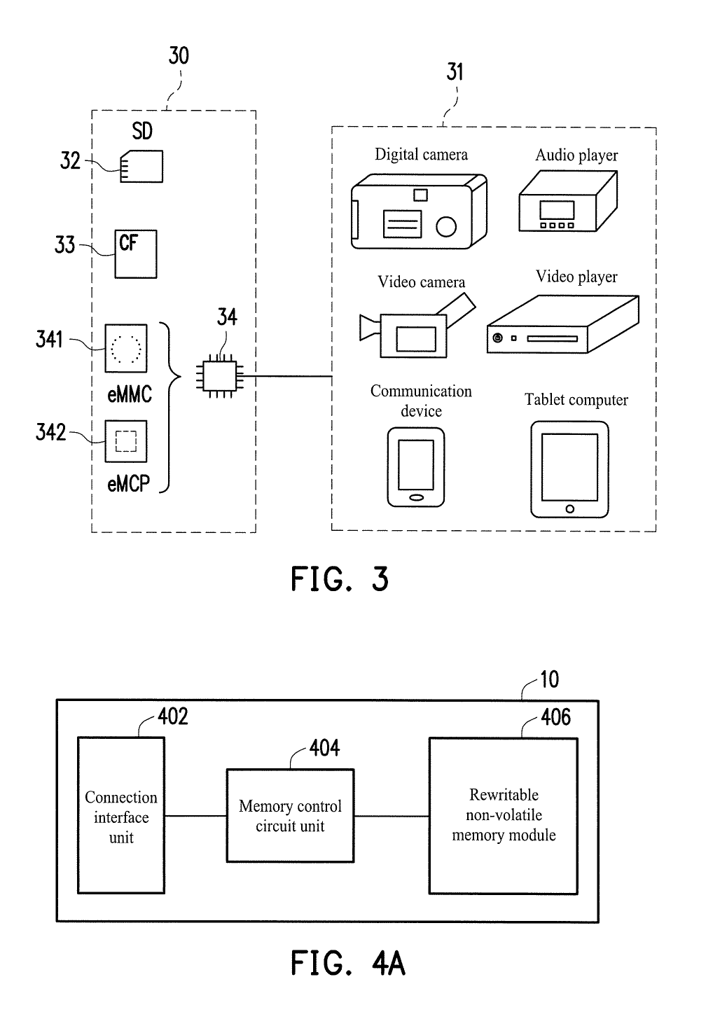

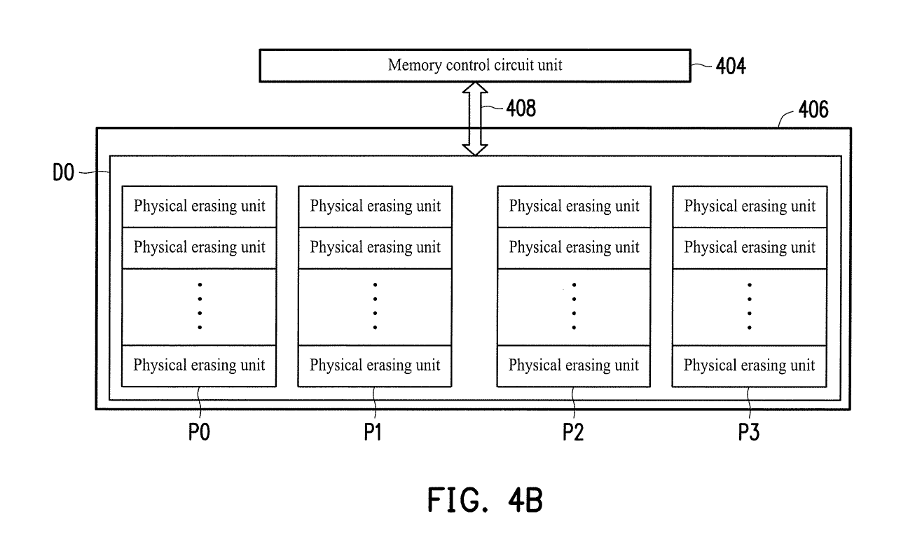

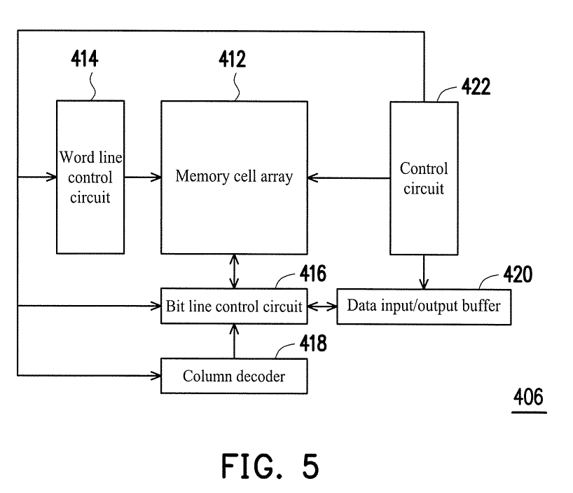

FIG. 4A is a schematic block diagram illustrating a memory storage apparatus according to an exemplary embodiment.

Referring to FIG. 4A, the memory storage device 10 includes a connection interface unit 402, a memory controlling circuit unit 404 and a rewritable non-volatile memory storage module 406.

The connection interface unit 402 is configured to couple to the memory storage device 10 to the host system 11. In the present exemplary embodiment, the connection interface unit 402 is compatible with a Secure Digital (SD) interface standard. Nevertheless, it should be understood that the invention is not limited to the above. The connection interface unit 402 may also be compatible to a SATA (Serial Advanced Technology Attachment) standard, a PATA (Parallel Advanced Technology Attachment) standard, an IEEE (Institute of Electrical and Electronic Engineers) 1394 standard, a PCI Express (Peripheral Component Interconnect Express) interface standard, a USB (Universal Serial Bus) standard, a UHS-I (Ultra High Speed-I) interface standard, a UHS-II (Ultra High Speed-II) interface standard, a MS (Memory Stick) interface standard, a Multi-Chip Package interface standard, a MMC (Multi Media Card) interface standard, an eMMC (Embedded Multimedia Card) interface standard, a UFS (Universal Flash Storage) interface standard, an eMCP (embedded Multi Chip Package) interface standard, a CF (Compact Flash) interface standard, an IDE (Integrated Device Electronics) interface standard or other suitable standards. The connection interface unit 402 and the memory control circuit unit 404 may be packaged into one chip, or the connection interface unit 402 may be distributed outside a chip containing the memory control circuit unit.

The memory control circuit unit 404 is configured to execute a plurality of logic gates or control commands which are implemented in a hardware form or in a firmware form and perform operations such as writing, reading or erasing data in the rewritable non-volatile memory module 406 based on the commands of the host system 11.

The rewritable non-volatile memory module 406 is coupled to the memory control circuit unit 404 and configured to store data written from the host system 11. In the present exemplary embodiment, the rewritable non-volatile memory module 406 is a Trinary Level Cell (TLC) NAND flash memory module (i.e., a flash memory module capable of storing three data bits in one memory cell). However, the invention is not limited to the above. The rewritable non-volatile memory module 406 may also be a Multi Level Cell (MLC) NAND flash memory module, (i.e., a flash memory module capable of storing two data bits in one memory cell), a Single Level Cell (SLC) NAND flash memory module (i.e., a flash memory module capable of storing one data bits in one memory cell), other flash memory modules or other memory modules having the same features.

In the present exemplary embodiment, the memory cells of the rewritable non-volatile memory module 406 constitute a plurality of physical programming units, and the physical programming units constitute a plurality of physical erasing units. For example, the memory cells on the same word line constitute one or more physical programming units. If each of the memory cells can store more than one data bit, the physical programming units on the same word line can be at least classified into a lower physical programming unit and an upper physical programming unit. For instance, because each memory cell of the SLC NAND flash memory can store one bit of data, the memory cells arranged on the same word line are corresponding to one physical programming unit in the SLC NAND flash memory. In comparison with the SLC NAND flash memory, each memory cell of the MLC NAND flash memory can store two bits of data, and each storage state (i.e., “11”, “10”, “01” and “00”) includes a LSB (Least Significant Bit) and a MSB (Most Significant Bit). For example, in one storage state, the value of a first bit counted from the left is the LSB, and the value of a second bit counted from the left is the MSB. Accordingly, the memory cells arranged on the same word line can constitute two physical programming units. Here, the physical programming unit constituted by the LSBs of said memory cells is known as the lower physical programming unit, and the physical programming unit constituted by the MSBs of said memory cells is known as the upper physical programming unit. In general, in the MLC NAND flash memory, a writing speed of the lower physical programming unit is higher than a writing speed of the upper physical programming unit, and/or a reliability of the lower physical programming unit is higher than a reliability of the upper physical programming unit.

Similarly, each memory cell in the TLC NAND flash memory can store three bits of data, wherein each storage state (i.e., “111”, “110”, “101”, “100”, “011”, “010”, “001” and “000”) includes a first bit counted from the left being the LSB, a second bit counted from the left being a CSB (Center Significant Bit) and a third bit counted from the left being the MSB. Accordingly, the memory cells arranged on the same word line can constitute three physical programming units. Here, the physical programming unit constituted by the LSBs of said memory cells is known as the lower physical programming unit, the physical programming unit constituted by the CSBs of said memory cells is known as a center physical programming unit, and the physical programming unit constituted by the MSBs of said memory cells is known the an upper physical programming unit.

In the present exemplary embodiment, the physical programming unit is the minimum unit for programming. That is, the physical programming unit is the minimum unit for writing data. For example, the physical programming unit is a physical page or a physical sector. If the physical programming unit is the physical page, the physical programming unit usually include a data bit area and a redundancy bit area. The data bit area includes multiple physical sectors configured to store user data, and the redundant bit area is configured to store system data (e.g., management data such as the error correcting code, etc.). In the present exemplary embodiment, the data bit area includes 32 physical sectors, and a size of each physical sector is 512 bytes (B). However, in other exemplary embodiments, the data bit area may also include 8, 16 physical sectors or different number (more or less) of the physical sectors, and the size of each physical sector may also be greater or smaller. On the other hand, the physical erasing unit is the minimum unit for erasing. Namely, each physical erasing unit contains the least number of memory cells to be erased together. For instance, the physical erasing unit is a physical block.

In the present exemplary embodiment, the rewritable non-volatile memory module 406 has a plurality of planes, and each of the planes belongs to one die. In an exemplary embodiment, the number of the planes may be greater than the number of the dies. In other words, two or more than two planes may belong to one die. Each physical erasing unit in the rewritable non-volatile memory module 406 belongs to one plane. Each plane can include multiple physical erasing units and multiple physical programming units.

FIG. 4B is a schematic diagram illustrating a rewritable non-volatile memory module coupled to a memory control circuit unit according to an exemplary embodiment.

With reference to FIG. 4B, the rewritable non-volatile memory module 406 has a die D0, and the die D0 includes four planes P0 to P3. Each plane among the planes P0 to P3 has a plurality of physical erasing units, and each of the physical erasing units has a plurality of physical programming units.

In the present exemplary embodiment, the die D0 is coupled to the memory control circuit unit 404 through a chip enable pin. The memory control circuit unit 404 can send an enable signal to the chip enable pin of the die D0 to enable the die D0. After the die D0 is enabled, data can be transmitted between the memory control circuit unit 404 and the die D0 through a channel 408 (e.g., a data bus). In other words, the physical programming units belonging to the planes P0 to P3 of the die D0 are accessed through the channel 408, and data stored in the planes P0 to P3 can be read in parallel by using a multi-plane accessing operation.

However, in an example where multiple dies are provided, the memory control circuit unit 404 can also simultaneously enable multiple dies by one enable signal or enable multiple dies respectively by using multiple enable signals. Also, the data stored in the different dies can be accessed through different channels. Taking FIG. 4B as an example, it is assumed that the plane P0 and the plane P1 belong to one die, and the plane P2 and the plane P3 belong to another die. Data stored in the plane P0 and the plane P1 can be accessed through one channel, and data stored in the plane P2 and the plane P3 can be accessed through another channel.

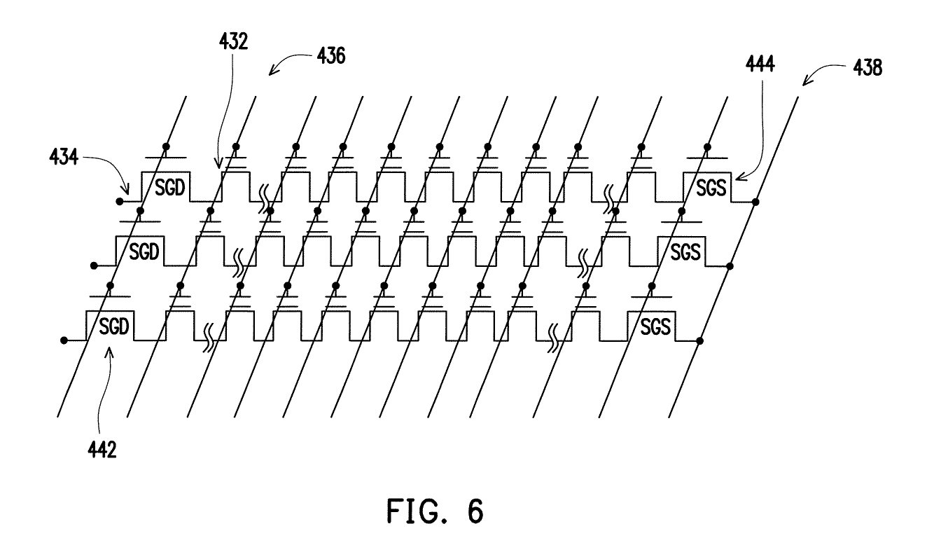

FIG. 5 is a schematic block diagram illustrating a rewritable non-volatile memory module according to an exemplary embodiment of the invention. FIG. 6 is a schematic diagram illustrating a memory cell array according to an exemplary embodiment of the invention.

Referring to FIG. 5, the rewritable non-volatile memory module 406 includes a memory cell array 412, a word line control circuit 414, a bit line control circuit 416, a column decoder 418, a data input-output buffer 420 and a control circuit 422.

In the present exemplary embodiment, the memory cell array 412 may include a plurality of memory cells 432 for storing data, a plurality of select gate drain (SGD) transistors 442, a plurality of select gate source (SGS) transistors 444, a plurality of bit lines 434, a plurality of word lines 436, and a common source line 438, where the bit lines 434, the word lines 436, and the common source line 438 are connected to the memory cells (as shown in FIG. 6). The memory cell 432 is disposed at intersections of the bit lines 434 and the word lines 436 in a matrix manner (or in a 3D stacking manner). When a write command or a read command is received from the memory control circuit unit 404, the control circuit 422 controls the word line control circuit 414, the bit line control circuit 416, the column decoder 418, the data input-output buffer 420 to write the data into the memory cell array 412 or read the data from the memory cell array 412, wherein the word line control circuit 414 is configured to control voltages applied to the word lines 436, the bit line control circuit 416 is configured to control voltages applied to the bit lines 434, the column decoder 418 is configured to select the corresponding bit line according to a row address in a command, and the data input/output buffer 420 is configured to temporarily store data.

Each of the memory cells in the rewritable non-volatile memory module 406 may store one or more bits by changing a threshold voltage of the memory cell. More specifically, in each of the memory cells, a charge trapping layer is provided between a control gate and a channel. Amount of electrons in the charge trapping layer may be changed by applying a write voltage to the control gate thereby changing the threshold voltage of the memory cell. This process of changing the threshold voltage is also known as “writing data into the memory cell” or “programming the memory cell”. Each of the memory cells in the memory cell array 412 has a plurality of storage statuses depended on changes in the threshold voltage. A read voltage can be used to determine what storage state the memory cell belongs to, so as to obtain one or more bits stored by the memory cell.

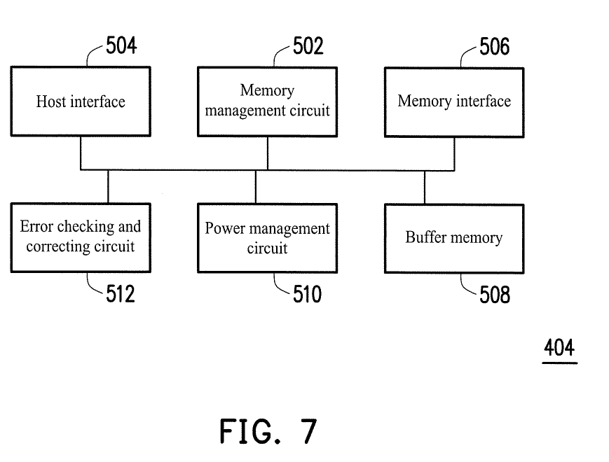

FIG. 7 is a schematic block diagram illustrating a memory control circuit unit according to an exemplary embodiment.

Referring to FIG. 7, the memory control circuit unit 404 includes a memory management circuit 502, a host interface 504 and a memory interface 506.

The memory management circuit 502 is configured to control overall operations of the memory control circuit unit 404. Specifically, the memory management circuit 502 has a plurality of control commands and the control commands are executed to perform various operations such as writing, reading and erasing data during operation of the memory storage device 10.

In the present exemplary embodiment, the control commands of the memory management circuit 502 are implemented in form of firmware. For instance, the memory management circuit 502 has a microprocessor unit (not illustrated) and a read-only memory (not illustrated), and the control commands are burnt into the read-only memory. During operation of the memory storage device 10, the control commands are executed by the microprocessor to perform operations of writing, reading or erasing data.

In another exemplary embodiment of the invention, the control commands of the memory management circuit 502 may also be stored, in form of program codes, into a specific area (e.g., a system area in the memory module exclusively for storing the system data) of the rewritable non-volatile memory module 406. In addition, the memory management circuit 502 has a microprocessor unit (not illustrated), a ROM (not illustrated) and a RAM (not illustrated). In particular, the ROM has a boot code, which is executed by the microprocessor unit to load the control commands stored in the rewritable non-volatile memory module 406 to the RAM of the memory management circuit 502 when the memory control circuit unit 404 is enabled. Then, the control commands are executed by the microprocessor unit to perform operations of writing, reading or erasing data.

Further, in another exemplary embodiment of the invention, the control commands of the memory management circuit 502 may also be implemented in a form of hardware. For example, the memory management circuit 502 includes a microprocessor, a memory cell management circuit, a memory writing circuit, a memory reading circuit, a memory erasing circuit and a data processing circuit. The memory cell management circuit, the memory writing circuit, the memory reading circuit, the memory erasing circuit and the data processing circuit are coupled to the microprocessor. The memory cell management circuit is configured to manage the physical erasing units of the rewritable non-volatile memory module 406; the memory writing circuit is configured to give a write command to the rewritable non-volatile memory module 406 in order to write data into the rewritable non-volatile memory module 406; the memory reading circuit is configured to give a read command to the rewritable non-volatile memory module 406 in order to read data from the rewritable non-volatile memory module 406; the memory erasing circuit is configured to give an erase command to the rewritable non-volatile memory module 406 in order to erase data from the rewritable non-volatile memory module 406; and the data processing circuit is configured to process both the data to be written into the rewritable non-volatile memory module 406 and the data read from the rewritable non-volatile memory module 406.

The host interface 504 is coupled to the memory management circuit 502 and configured to couple to the connection interface unit 402, so as to receive and identify commands and data sent from the host system 11. In other words, the commands and data transmitted by the host system 11 are transmitted to the memory management circuit 502 via the host interface 504. In the present exemplary embodiment, the host interface 504 is compatible with the SATA standard. Nevertheless, it should be understood that the invention is not limited to the above. The host interface 504 may also be compatible with the PATA standard, the IEEE 1394 standard, the PCI Express standard, the USB standard, the UHS-I interface standard, the UHS-II interface standard, the SD standard, the MS standard, the MMC standard, the CF standard, the IDE standard, or other suitable standards for data transmission.

The memory interface 506 is coupled to the memory management circuit 502 and configured to access the rewritable non-volatile memory module 406. In other words, data to be written into the rewritable non-volatile memory module 406 is converted into a format acceptable by the rewritable non-volatile memory module 406 via the memory interface 506.

In an exemplary embodiment, the memory control circuit unit 404 further includes a buffer memory 508, a power management circuit 510 and an error checking and correcting circuit 512.

The buffer memory 508 is coupled to the memory management circuit 502 and configured to temporarily store data and commands from the host system 11 or data from the rewritable non-volatile memory module 406.

The power management unit 510 is coupled to the memory management circuit 502 and configured to control a power of the memory storage device 10.

The error checking and correcting circuit 512 is coupled to the memory management circuit 502 and configured to execute an error checking and correcting procedure to ensure the data integrity. For example, when the memory management circuit 502 receives the write command from the host system 11, the error checking and correcting circuit 512 generates an ECC (error correcting code) and/or an EDC (error detecting code) for data corresponding to the write command, and the memory management circuit 502 writes data corresponding to the write command and the corresponding ECC and/or the EDC into the rewritable non-volatile memory module 406. Then, when the memory management circuit 502 reads the data from the rewritable non-volatile memory module 406, the corresponding ECC and/or the EDC are also read, and the error checking and correcting circuit 512 performs the error checking and correcting operation on the read data based on the ECC and/or the EDC.

In the following description, the operations executed by the memory management circuit 502, the host interface 504, the memory interface 506, the buffer memory 508, the power management circuit 510 and the error checking and correcting circuit 512 may also be referred to as being executed by the memory control circuit unit 404.

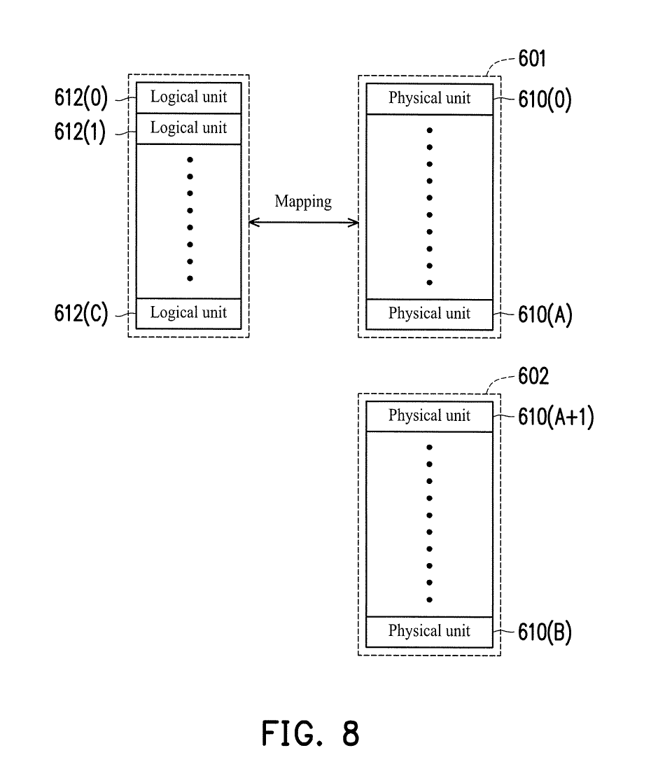

FIG. 8 is a schematic diagram illustrating management of a rewritable non-volatile memory module according to an exemplary embodiment of the invention.

Referring to FIG. 8, the memory management circuit 502 logically groups physical units 610(0) to 610(B) of the rewritable non-volatile memory module 406 into a storage area 601 and a replacement area 602. The physical units 610(0) to 610(A) in the storage area 601 are configured to store data, and the physical units 610(A+1) to 610(B) in the replacement area 602 are configured to replace damaged physical units in the storage area 601. For example, if data read from one specific physical unit includes too many errors and these error cannot be corrected, the specific physical unit is treated as a damaged physical unit. It should be noted that, if there is no available physical erasing unit in the storage area 602, the memory management circuit 502 may pronounce that the memory storage device 10 is in a write protect state so data can no longer be written thereto.

In the present exemplary embodiment, each physical unit refers to one physical erasing unit. However, in another exemplary embodiment, one physical unit may also refer to one physical address, one physical programming unit, or a composition of a plurality of continuous or discontinuous physical addresses. The memory management circuit 502 assigns logical units 612 (0) to 612(C) for mapping to the physical units 610(0) to 610(A) in the storage area 601. In the present exemplary embodiment, each logical unit refers to one logical address. However, in another exemplary embodiment, each logical unit may also refer to one logical programming unit, one logical erasing unit or a composition of a plurality of continuous or discontinuous logical addresses. In addition, each of the logical units 612(0) to 612(C) may also be mapped to one or more physical units.

In the present exemplary embodiment, the memory management circuit 502 records a mapping relation (a.k.a. a logical-physical address mapping relation) between the logical units and the physical units into at least one logical-physical address mapping table. When the host system 11 intends to read the data from the memory storage device 10 or write the data into the memory storage device 10, the memory management circuit 502 can perform a data accessing operation on the memory storage device 10 according to the logical-physical address mapping table.

It is noted that in the following description, some terms may be replaced with corresponding abbreviations for ease of reading (see Table 1).

TABLE 1

| rewritable non-volatile memory module | RNVM module |
|---|---|
| physical erasing unit | PEU |
| physical programming unit | PPU |
| memory management circuit | MMC |

When the host system 11 intends to read data stored in the RNVM module 406, the host system 11 transmits one or more read commands. The MMC 502 can temporarily store the read commands received from the host system 11 into the buffer memory 508. For example, the MMC 502 can create one command queue for storing the received read commands. The read commands instruct reading a plurality of logical addresses, and the MMC 502 executes a reading operation according to the logical addresses. In the present exemplary embodiment, one read command instructs reading one logical address, and one logical address can map to one PPU. However, in other exemplary embodiments, one read command can also instruct reading multiple logical addresses. In other words, the host system 11 can transmit one read command to instruct reading a plurality of data stored in multiple PPUs of the RNVM module 406.

In an exemplary embodiment, before executing the reading operation according to the logical addresses instructed by the read commands, the MMC 502 determines a reading order corresponding to the logical addresses according to a preset rule. In an exemplary embodiment, the preset rule is set according to the dies and the planes of the RNVM module 406. For example, according to the preset rule, the MMC 502 can first execute a reading operation corresponding to logical addresses of one die and then execute a reading operation corresponding to logical addresses of another die. Alternatively, according to the preset rule, the MMC 502 can preferentially execute the reading operation corresponding to logical addresses of different planes. Alternatively, according to the preset rule, the MMC 502 can first execute the reading operation for data that can be read in parallel and then execute the reading operation for data that cannot be read in parallel. Alternatively, according to the preset rule, the MMC 502 can first execute the reading operation for data that cannot be read in parallel before executing the reading operation for data that can be read in parallel.

In another exemplary embodiment, the PEUs of the RNVM module 406 may further be divided into PEUs belonging to a first use area and PEUs belonging to a second use area. In other words, the PPUs of the RNVM module 406 can be divided into PPUs belonging to the first use area and PPUs belonging to the second use area. The PPU belonging to the first use area is programmed by a first programming mode, and the PPU belonging to the second use area is programmed by a second programming mode. In other words, data stored in the PPU belonging to the first use area is programmed by the first programming mode, and data stored in the PPU belonging to the second use area is programmed by the second programming mode. In this exemplary embodiment, the preset rule may also be set according to the first use area and the second use area of the RNVM module 406. For example, according to the preset rule, the MMC 502 can preferentially execute the reading operation corresponding to the logical address of the first use area before executing the reading operation corresponding to the logical addresses of the second use area.

In the present exemplary embodiment, the memory cell programmed by the first programming mode can store data of a first number of bits, and the memory cell programmed by the second programming mode can store data of a second number of bits, where the second number is greater than the first number. For instance, the first programming mode may be a single level cell (SLC) programming mode, and the second programming mode may be a trinary level cell (TLC) programming mode or a multi level cell (MLC) programming mode. In the SLC programming mode, one memory cell can store one bit of data. In the MLC programming mode, one memory cell can store two bits of data. In the TLC programming mode, one memory cell can store three bits of data. However, the invention is not limited to the above. The first number may also be greater than the second number. In this case, the first programming mode may be the TLC programming mode or the MLC programming mode, and the second programming mode may be the SLC programming mode.

Moreover, in another exemplary embodiment, data stored in the PPU has a corresponding priority. In this exemplary embodiment, the preset rule may further be set according to the priority of the data, and the MMC 502 executes the reading operation for the data corresponding to the higher priority. The priority of the data may be determined according to a property of the data or a storage area of the data. The property of the data may be an importance degree of the data, an updating frequency of the data or a type of the data (e.g., the system data). For example, the priority of the data corresponding to high importance is higher than the priority of the data corresponding to low importance. The priority of the data with high updating frequency is higher than the priority of the data with low updating frequency. The system data has the highest priority. The storage area of the data may be the first use area and the second use area divided according to aforesaid programming modes. For example, data belonging to the first use area (i.e., the data programmed by the SLC programming mode) is the data with the higher importance, and thus has the higher priority. Data belonging to the second use area (i.e., the data programmed by the MLC programming mode or the TLC programming mode) belongs to the data with the lower importance, and thus has the lower priority.

In brief, the preset rule may be set according to the dies, the planes, the use areas of the RNVM module 406, whether data is the data that can be read in parallel or the data that cannot be read in parallel, or the priority of the data. The MMC 502 can determine the reading order of the logical addresses instructed by the read commands from the host system 11 according to the reset rule, and execute one or more reading operations corresponding to the logical addresses according to the reading order. In addition, the MMC 502 selects logical address corresponding to the data that can be read in parallel from aforesaid logic addresses according to a preset condition for executing a parallel reading operation. In other words, said one or more reading operations corresponding to the logical addresses include the parallel reading operation corresponding to the logical address meeting the preset condition. In an exemplary embodiment, the preset condition includes that a plurality of PPUs, mapping to a plurality of selected logical addresses, respectively belong to different planes; these planes belong to the same die; and address index values of these PPUs are different from each other. In another exemplary embodiment, the preset condition further includes that the PPUs belong to the same use area.

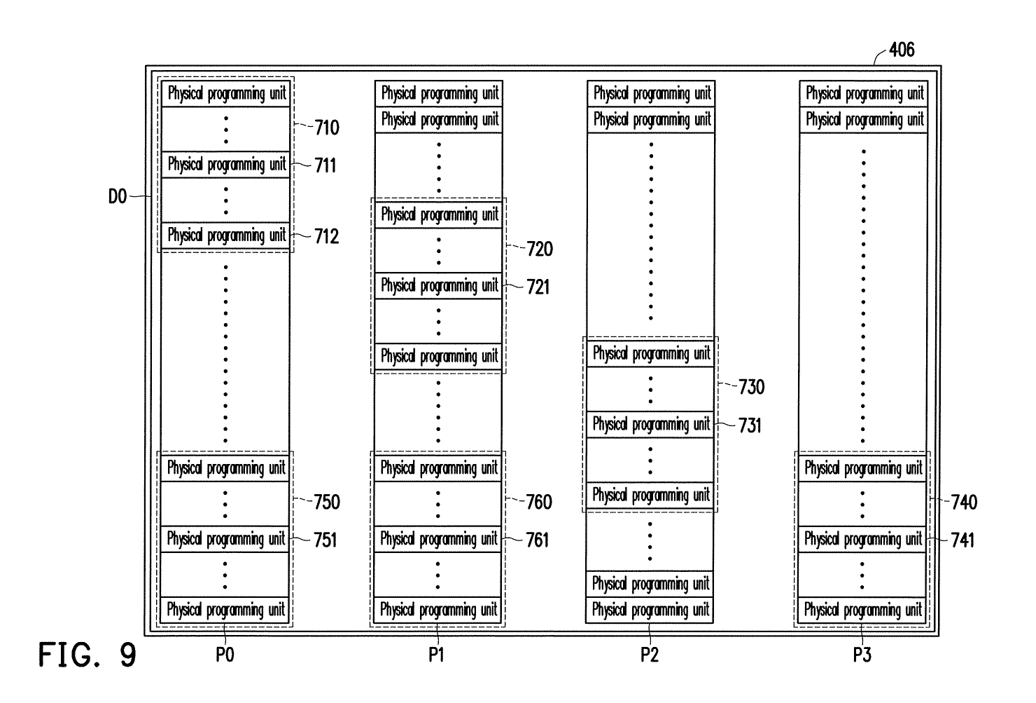

FIG. 9 is a schematic diagram illustrating PPUs corresponding to read commands according to an exemplary embodiment of the invention. The structure of the RNVM module 406 of FIG. 9 is identical to the structure of the RNVM module 406 of FIG. 4B. It should be noted that, locations of each PEU and each PPU in FIG. 9 are only illustrative rather than used to limit their actual locations in the RNVM module 406. The data reading method of the invention is described below with reference to FIG. 9.

With reference to FIG. 9, the RNVM module 406 has the die D0, and the die D0 includes the planes P0 to P3. The MMC 502 accesses data stored in the die D0 through one channel. A PEU 710 and a PEU 750 belong to the plane P0; a PEU 720 and a PEU 760 belong to the plane P1; a PEU 730 belongs to the plane P2; a PEU 740 belongs to the plane P3. A PPU 711 and a PPU 712 belong to the PEU 710; a PPU 721 belongs to the PEU 720; a PPU 731 belongs to the PEU 730; a PPU 741 belongs to the PEU 740; a PPU 751 belongs to the PEU 750; a PPU 761 belongs to the PEU 760.

It is assumed that the MMC 502 receives a plurality of read commands from the host system 11, and these read commands instruct reading data from a plurality of logical addresses. The MMC 502 determines a reading order for the logical addresses according to a preset rule. In addition, the MMC 502 also selects a plurality of logical addresses meeting a preset condition from these logical addresses. For instance, these logical addresses include a plurality of logical addresses meeting the preset condition and at least one logical address not meeting the preset condition. The MMC 502 selects the logical addresses meeting the preset condition according to the PPUs mapping to the logical addresses. In the preset exemplary embodiment, data stored in the PPUs mapping to the logical addresses meeting the preset condition can be read in parallel. Subsequently, the MMC 502 can preferentially execute the data reading operation corresponding to the logical addresses meeting the preset condition, so as to read the data in the PPUs mapping to the logical addresses meeting the preset condition in parallel. The data stored in the PPUs mapping to the selected logical addresses can be simultaneously read by one multi-plane reading operation.

In the present exemplary embodiment, the MMC 502 can read the data stored in the PPUs on different planes of the die D0 in parallel through one channel by using the multi-plane reading operation. When executing the multi-plane reading operation, the MMC 502 first sends an address command to the RNVM module 406, and the address command can include only row addresses of the PPUs to be read in parallel. Then, the MMC 502 then sends a read action command to the RNVM module 406 to instruct executing the reading operation according to the address command. Then, the MMC 502 can send the address command to the RNVM module 406 again, and the address command can include only column addresses of the PPUs to be read in parallel. Then, the MMC 502 can send the read action command to the RNVM module 406, so as to instruct executing the reading operation according to the column addresses of the PPUs to be read in parallel.

In an exemplary embodiment, the MMC 502 selects the PPUs of different planes belonging to the same die, so as to select the logical addresses meeting the preset condition. Taking FIG. 9 as an example, it is assumed that the logical addresses sequentially instructed by the read commands from the host system 11 respectively map to the PPU 711, the PPU 712, the PPU 731, the PPU 721, the PPU 741 and the PPU 751. As shown in FIG. 9, the PPU 711 belongs to the plane P0, the PPU 721 belongs to the plane P1, the PPU 731 belongs to the plane P2 and the PPU 741 belongs to the plane P3. Accordingly, the MMC 502 selects the PPU 711, the PPU 721, the PPU 731 and the PPU 741 for executing the multi-plane reading operation.

When the MMC 502 executes the reading operations according to the read commands, the MMC 502 preferentially executes the multi-plane reading operation. In an example where one die includes four planes, the multi-plane reading operation executed by the MMC 502 may be a four-plane reading operation. For example, the MMC 502 can execute one four-plane reading operation to read data stored in the PPU 711, the PPU 721, the PPU 731 and the PPU 741 in parallel.

It is noted that, in the present exemplary embodiment, although it is described that one die of the RNVM module 406 includes four planes, the invention is not limited thereto. Nevertheless, in another exemplary embodiment, one die of the RNVM module 406 may also include other number of planes (e.g., one die includes two planes).

In the example of FIG. 9, it is assumed that the die D0 only includes the planes P0 and P1. It is further assumed that the logical addresses sequentially instructed by the read commands from the host system 11 respectively map to the PPU 711, the PPU 712, the PPU 731, the PPU 721, the PPU 741 and the PPU 751. The MMC 502 selects the PPU 711 and the PPU 721 for executing one multi-plane reading operation so as to execute the reading operation for the logical addresses mapping to the PPU 711 and the PPU 721, and selects the PPU 731 and the PPU 741 for executing another multi-plane reading operation so as to execute the reading operation for the logical addresses mapping to the PPU 731 and the PPU 741. In this case, the multi-plane reading operation executed by the MMC 502 may be a two-plane reading operation. For example, the MMC 502 can execute one two-plane reading operation to read data stored in the PPU 711 and the PPU 721 in parallel, and execute another two-plane reading operation to read data stored in the PPU 731 and the PPU 741 in parallel.

After completing the multi-plane reading operation, the MMC 502 can execute the reading operation for the rest of the PPUs (e.g., the PPU 712 and the PPU 751). In an exemplary embodiment, after completing the four-plane reading operation for the PPU 711, the PPU 721, the PPU 731 and the PPU 741, the MMC 502 reads the data stored in the PPU 712 and the PPU 751, respectively. The logical addresses corresponding to the PPU 712 and the PPU 751 refer to the logical addresses not meeting the preset condition. The MMC 502 can sequentially read data stored in the PPU 712 and the PPU 751 according to an order instructed by the read commands. In an exemplary embodiment, after completing the two-plane reading operation for the PPU 711 and the PPU 721, the MMC 502 reads the data stored in the PPU 712 and the PPU 751, respectively. Then, the MMC 502 can execute the two-plane reading operation for the PPU 731 and the PPU 741. Alternatively, after completing the two-plane reading operation for the PPU 711 and the PPU 721 and the two-plane reading operation for the PPU 731 and the PPU 741, the MMC 502 then reads the data stored in the PPU 712 and the PPU 751, respectively.

In other words, the MMC 502 can first read the data that can be read in parallel (i.e., the data corresponding to the logical addresses meeting the preset condition) before reading the remaining data (i.e., the data corresponding to the logical addresses not meeting the preset condition). However, the invention is not limited to the above. In other exemplary embodiments, the MMC 502 may first read the data that cannot be read in parallel corresponding to the logical addresses not meeting the preset condition before reading the data that can be read in parallel.

In particular, in this invention, the PPUs in which the data can be read in parallel by one multi-plane reading operation may have the different address index values. In other words, the PPUs mapping to the logical addresses meeting the preset condition may have different addresses index values. The address index value of one specific PPU can be used to indicate an address offset of a starting address of that specific PPU relative to a specific address. The specific address may be a starting address of the PEU to which said specific PPU belongs. The address index value may be represented by a preset mark or offset. In the present exemplary embodiment, if the PPU 711 is an i^{th} PPU in the PEU 710, the preset mark of the PPU 711 may be i, and the offset of the PPU 711 may be a size of one PPU multiplied by i. In this way, according to the address index values, the PPU 711 is identified as the i^{th} PPU in the PEU 710, and the PPU 721 is identified as a j^{th} PPU in the PEU 720, where i may not be equal to j. Similarly, according to the address index values, the PPU 731 is identified as an m^{th} PPU in the PEU 730, and the PPU 741 is identified as an n^{th} PPU in the PEU 740, where m may not be equal to n.

In another exemplary embodiment, the PEUs of the RNVM module 406 may further be divided into PEUs belonging to the first use area and PEUs belonging to the second use area. In this exemplary embodiment, the PPUs mapping to the logical addresses meeting the preset condition belong to the same use area. In other words, the MMC 502 can find the PPUs belonging to different planes and belonging to the same use area (which may be the first use area or the second use area), and read data stored in these PPUs in parallel.

More specifically, the MMC 502 selects the PPUs belonging to different planes and belonging to the same use area for executing the multi-plane reading operation, and these PPUs can include the PPUs having different address index values. The PPUs belonging to the same use area are the PPUs programmed by the same programming mode.

In an exemplary embodiment, it is assumed that the planes P0 to P3 belong to the same die, and the logical addresses sequentially instructed by the read commands from the host system 11 respectively map to the PPU 711 of the PEU 710, the PPU 731 of the PEU 730, the PPU 721 of the PEU 720 and the PPU 741 of the PEU 740. The PPU 711, the PPU 721, the PPU 731 and the PPU 741 belong to different planes and belong to the first use area (or the second use area). The MMC 502 selects the PPU 711, the PPU 721, the PPU 731 and the PPU 741 for executing the multi-plane reading operation. Accordingly, when executing the reading operation, the MMC 502 executes one four-plane reading operation to read data stored in the PPU 711 the PPU 721, the PPU 731 and the PPU 741 in parallel.

In an exemplary embodiment, it is assumed that the planes P0 and P1 belong to one die, the planes P2 and P3 belong to another die, and the logical addresses sequentially instructed by the read commands from the host system 11 respectively map to the PPU 721 of the PEU 720, the PPU 761 of the PEU 760, the PPU 711 of the PEU 710 and the PPU 751 of the PEU 750. The PPU 721 and the PPU 751 belong to different planes of the same die and belong to the first use area. The PPU 711 and the PPU 761 belong to different planes of the same die and belong to the second use area. The MMC 502 selects the PPU 721 and the PPU 751 for executing the multi-plane reading operation. In addition, the MMC 502 selects the PPU 761 and the PPU 711 for executing the multi-plane reading operation. Accordingly, the MMC 502 can execute one two-plane reading operation to read data stored in the PPU 721 and the PPU 751 in parallel. The MMC 502 can also execute another two-plane reading operation to read data stored in the PPU 711 and the PPU 761 in parallel. In particular, the address index value of the PPU 711 may be different from the address index value of the PPU 761, and the address index value of the PPU 721 may be different from the address index value of the PPU 751.

In another exemplary embodiment, it is assumed that the logical addresses sequentially instructed by the read commands from the host system 11 respectively map to the PPU 711 of the PEU 710 and the PPU 721 of the PEU 720. The PPU 711 belongs to the first use area, and the PPU 721 belongs to the second use area. The MMC 502 separately reads data stored in the PPU 711 and data stored in the PPU 721. In other words, because the programming mode of the PPU 711 is different from the programming mode of the PPU 721, even though the PPU 711 and the PPU 721 belong to different planes of the same die, the MMC 502 does not select the PPU 711 and the PPU 721 for executing the multi-plane reading operation.

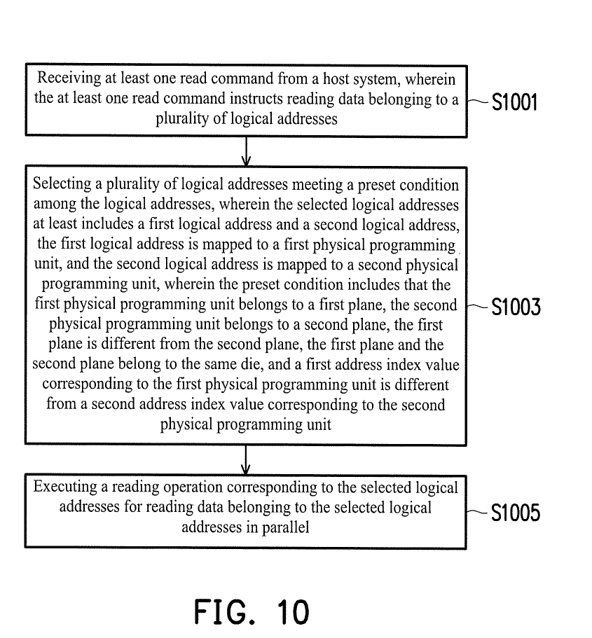

FIG. 10 is a flowchart illustrating a data reading method according to an exemplary embodiment of the invention.

With reference to FIG. 10, in step S1001, the MMC 502 receives at least one read command from the host system 11, wherein the at least one read command instructs reading data belonging to a plurality of logical addresses.

Next, in step S1003, the MMC 502 selects a plurality of logical addresses meeting a preset condition among said logical addresses, wherein the selected logical addresses at least includes a first logical address and a second logical address, the first logical address is mapped to a first PPU, the second logical address is mapped to a second PPU, wherein the preset condition includes that the first PPU belongs to a first plane, the second PPU belongs to a second plane, the first plane is different from the second plane, the first plane and the second plane belong to the same die, and a first address index value corresponding to the first PPU is different from a second address index value corresponding to the second PPU. In an exemplary embodiment, the first PPU and the second PPU are programmed by the same programming mode and thus belong to the same use area.

In step S1005, the MMC 502 executes a reading operation corresponding to the selected logical addresses for reading data belonging to the selected logical addresses in parallel. In other words, the MMC 502 can read the data stored in the first PPU and the second PPU in parallel by using one multi-plane reading operation. In addition, the MMC 502 can also determine the reading order corresponding to the logical addresses according to the preset rule, and sequentially execute the reading operation corresponding to the selected logical addresses meeting the preset condition and the reading operation corresponding to the logical addresses not meeting the preset condition according to the reading order. Details regarding each step in FIG. 10 have been described in the foregoing embodiments, and thus related descriptions are not repeated hereinafter.

In summary, according to the invention, by selecting the PPUs belonging to different planes of the same die and corresponding to the different address index values for executing the multi-plane reading operation, the data stored in the PPUs corresponding to the random reading operation can be simultaneously read by using the multi-plane reading operation. As a result, the data reading speed corresponding to the random reading operation can be accelerated.

The previously described exemplary embodiments of the present disclosure have the advantages aforementioned, wherein the advantages aforementioned not required in all versions of the disclosure.

It will be apparent to those skilled in the art that various modifications and variations can be made to the structure of the present invention without departing from the scope or spirit of the invention. In view of the foregoing, it is intended that the present invention cover modifications and variations of this invention provided they fall within the scope of the following claims and their equivalents.

What is claimed is:

1. A data reading method for a rewritable non-volatile memory module, wherein the rewritable non-volatile memory module comprises at least one die, a plurality of planes and a plurality of physical programming units, and the data reading method comprises:
receiving at least one read command from a host system, wherein the at least one read command instructs reading data belonging to a plurality of logical addresses;
selecting a plurality of logical addresses meeting a preset condition among the logical addresses, wherein the selected logical addresses at least comprise a first logical address and a second logical address, the first logical address is mapped to a first physical programming unit among the physical programming units, the second logical address is mapped to a second physical programming unit among the physical programming units, wherein the preset condition comprises that the first physical programming unit belongs to a first plane among the planes, the second physical programming unit belongs to a second plane among the planes, the first plane is different from the second plane, the first plane and the second plane belong to a same die among the at least one die, and a first address index value corresponding to the first physical programming unit is different from a second address index value corresponding to the second physical programming unit; and
executing a reading operation corresponding to the selected logical addresses for reading data belonging to the selected logical addresses in parallel.

2. The data reading method according to claim 1, wherein the selected logical addresses further comprise a third logical address and a fourth logical address, the third logical address is mapped to a third physical programming unit among the physical programming units, the fourth logical address is mapped to a fourth physical programming unit among the physical programming units, wherein the preset condition further comprises that the third physical programming unit belongs to a third plane among the planes, and the fourth physical programming unit belongs to a fourth plane among the planes, wherein the first plane, the second plane, the third plane and the fourth plane are different from each other, wherein the first plane, the second plane, the third plane and the fourth plane belong to the same die among the at least one die.

3. The data reading method of claim 1, further comprising:
determining a reading order for the logical addresses according to a preset rule; and
executing at least one reading operation corresponding to the logical addresses according to the reading order,
wherein the at least one reading operation corresponding to the logical addresses comprises the reading operation corresponding to the selected logical addresses.

4. The data reading method according to claim 3, wherein the logical addresses further comprise at least one logical address not meeting the preset condition, wherein the step of executing the at least one reading operation corresponding to the logical addresses according to the reading order comprises:
executing the reading operation corresponding to the selected logical addresses according to the reading order, and executing at least one reading operation corresponding to the at least one logical address not meeting the preset condition after the reading operation corresponding to the selected logical addresses is completed.

5. The data reading method according to claim 3, wherein the logical addresses further comprise at least one logical address not meeting the preset condition, wherein the step of executing the at least one reading operation corresponding to the logical addresses according to the reading order comprises:
executing at least one reading operation corresponding to the at least one logical address not meeting the preset condition according to the reading order, and executing the reading operation corresponding to the selected logical addresses after the at least one reading operation corresponding to the at least one logical address not meeting the preset condition is completed.

6. The data reading method according to claim 1, wherein the physical programming units are classified into a first use area and a second use area, wherein a physical programming unit belonging to the first use area is programmed by a first programming mode, and a physical programming unit belonging to the second use area is programmed by a second programming mode, wherein the preset condition further comprises that the first physical programming unit and the second physical programming unit belong to a same use area.

7. The data reading method according to claim 6, wherein the first programming mode is a single level cell programming mode, and the second programming mode is a trinary level cell programming mode.

8. The data reading method according to claim 1, wherein each plane among the planes comprises a plurality of physical erasing units, and each physical erasing unit among the physical erasing units comprises a part of the physical programming units,
wherein the first physical programming unit belongs to a first physical erasing unit among the physical erasing units, and the second physical programming unit belongs to a second physical erasing unit among the physical erasing units, wherein the first address index value is configured to indicate an address offset of a starting address of the first physical programming unit relative to a start address of the first physical erasing unit, and the second address index value is configured to indicate an address offset of a starting address of the second physical programming unit relative to a start address of the second physical erasing unit.

9. The data reading method according to claim 1, wherein the step of executing the reading operation corresponding to the selected logical addresses for reading the data belonging to the selected logical addresses in parallel comprises:
sending an address command, wherein the address command includes only a row address corresponding to the first physical programming unit and a row address corresponding to the second physical programming unit, or includes only a column address corresponding to the first physical programming unit and a column address corresponding to the second physical programming unit; and
sending a read action command for reading data stored in the first physical programming unit and the second physical programming unit in parallel according to the address command.

10. A memory control circuit unit, for controlling a rewritable non-volatile memory module, wherein the rewritable non-volatile memory module comprises at least one die, a plurality of planes and a plurality of physical programming units, and the memory control circuit unit comprises:
a host interface, configured to couple to a host system;
a memory interface, configured to couple to the rewritable non-volatile memory module; and
a memory management circuit, coupled to the host interface and the memory interface;
wherein the memory management circuit is configured to receive at least one read command from the host system, wherein the at least one read command instructs reading data belonging to a plurality of logical addresses,
wherein the memory management circuit is further configured to select a plurality of logical addresses meeting a preset condition among the logical addresses, wherein the selected logical addresses at least comprise a first logical address and a second logical address, the first logical address is mapped to a first physical programming unit among the physical programming units, the second logical address is mapped to a second physical programming unit among the physical programming units, wherein the preset condition comprises that the first physical programming unit belongs to a first plane among the planes, the second physical programming unit belongs to a second plane among the planes, the first plane is different from the second plane, the first plane and the second plane belong to a same die among the at least one die, and a first address index value corresponding to the first physical programming unit is different from a second address index value corresponding to the second physical programming unit,
wherein the memory management circuit is further configured to execute a reading operation corresponding to the selected logical addresses for reading data belonging to the selected logical addresses in parallel.

11. The memory control circuit unit according to claim 10, wherein the selected logical addresses further comprise a third logical address and a fourth logical address, the third logical address is mapped to a third physical programming unit among the physical programming units, the fourth logical address is mapped to a fourth physical programming unit among the physical programming units, wherein the preset condition further comprises that the third physical programming unit belongs to a third plane among the planes, and the fourth physical programming unit belongs to a fourth plane among the planes, wherein the first plane, the second plane, the third plane and the fourth plane is different from each other, and the first plane, the second plane, the third plane and the fourth plane belongs to the same die among the at least one die.

12. The memory control circuit unit according to claim 10, wherein the memory management circuit is further configured to determine a reading order for the logical addresses according to a preset rule, and execute at least one reading operation corresponding to the logical addresses according to the reading order,
wherein the at least one reading operation corresponding to the logical addresses comprises the reading operation corresponding to the selected logical addresses.

13. The memory control circuit unit according to claim 12, wherein the logical addresses further comprise at least one logical address not meeting the preset condition, wherein the operation of executing the at least one reading operation corresponding to the logical addresses according to the reading order by the memory management circuit comprises:
executing the reading operation corresponding to the selected logical addresses according to the reading order, and executing at least one reading operation corresponding to the at least one logical address not meeting the preset condition after the reading operation corresponding to the selected logical addresses is completed.

14. The memory control circuit unit according to claim 12, wherein the logical addresses further comprise at least one logical address not meeting the preset condition, wherein the operation of executing the at least one reading operation corresponding to the logical addresses according to the reading order by the memory management circuit comprises:
executing at least one reading operation corresponding to the at least one logical address not meeting the preset condition according to the reading order, and executing the reading operation corresponding to the selected logical addresses after the at least one reading operation corresponding to the at least one logical address not meeting the preset condition is completed.

15. The memory control circuit unit according to claim 10, wherein the physical programming units are classified into a first use area and a second use area, wherein a physical programming unit belonging to the first use area is programmed by a first programming mode, and a physical programming unit belonging to the second use area is programmed by a second programming mode,
wherein the preset condition further comprises that the first physical programming unit and the second physical programming unit belong to a same use area.

16. The memory control circuit unit according to claim 15, wherein the first programming mode is a single level cell programming mode, and the second programming mode is a trinary level cell programming mode.

17. The memory control circuit unit according to claim 10, wherein each plane among the planes comprises a plurality of physical erasing units, and each physical erasing unit among the physical erasing units comprises a part of the physical programming units,
wherein the first physical programming unit belongs to a first physical erasing unit among the physical erasing units, and the second physical programming unit belongs to a second physical erasing unit among the physical erasing units, wherein the first address index value is configured to indicate an address offset of a starting address of the first physical programming unit relative to a start address of the first physical erasing unit, and the second address index value is configured to indicate an address offset of a starting address of the second physical programming unit relative to a start address of the second physical erasing unit.

18. The memory control circuit unit according to claim 10, wherein the operation of executing the reading operation corresponding to the selected logical addresses by the memory management circuit for reading the data belonging to the selected logical addresses in parallel comprises:
sending an address command, wherein the address command includes only a row address corresponding to the first physical programming unit and a row address corresponding to the second physical programming unit, or includes only a column address corresponding to the first physical programming unit and a column address corresponding to the second physical programming unit; and
sending a read action command for reading data stored in the first physical programming unit and the second physical programming unit in parallel according to the address command.

19. A memory storage device, comprising:
a connection interface unit, configured to couple to a host system;
a rewritable non-volatile memory module, comprising at least one die, a plurality of planes and a plurality of physical programming units; and
a memory control circuit unit, coupled to the connection interface unit and the rewritable non-volatile memory module,
wherein the memory control circuit unit is configured to receive at least one read command from the host system, wherein the at least one read command instructs reading data belonging to a plurality of logical addresses,
wherein the memory control circuit unit is further configured to select a plurality of logical addresses meeting a preset condition among the logical addresses, wherein the selected logical addresses at least comprise a first logical address and a second logical address, the first logical address is mapped to a first physical programming unit among the physical programming units, the second logical address is mapped to a second physical programming unit among the physical programming units, wherein the preset condition comprises that the first physical programming unit belongs to a first plane among the planes, the second physical programming unit belongs to a second plane among the planes, the first plane is different from the second plane, the first plane and the second plane belong to a same die among the at least one die, and a first address index value corresponding to the first physical programming unit is different from a second address index value corresponding to the second physical programming unit,
wherein the memory control circuit unit is further configured to execute a reading operation corresponding to the selected logical addresses for reading data belonging to the selected logical addresses in parallel.

20. The memory storage device according to claim 19, wherein the selected logical addresses further comprise a third logical address and a fourth logical address, wherein the third logical address maps to a third physical programming unit among the physical programming units, and the fourth logical address maps to a fourth physical programming unit among the physical programming units, wherein the preset condition further comprises that the third physical programming unit belongs to a third plane among the planes, the fourth physical programming unit belongs to a fourth plane among the planes, wherein the first plane, the second plane, the third plane and the fourth plane is different from each other, wherein the first plane, the second plane, the third plane and the fourth plane belong to the same die among the at least one die.

21. The memory storage device according to claim 19, wherein the memory control circuit unit is further configured to determine a reading order for the logical addresses according to a preset rule, and execute at least one reading operation corresponding to the logical addresses according to the reading order,
wherein the at least one reading operation corresponding to the logical addresses comprises the reading operation corresponding to the selected logical addresses.

22. The memory storage device according to claim 21, wherein the logical addresses further comprise at least one logical address not meeting the preset condition, wherein the operation of executing the at least one reading operation corresponding to the logical addresses according to the reading order by the memory control circuit unit comprises:
executing the reading operation corresponding to the selected logical addresses according to the reading order, and executing at least one reading operation corresponding to the at least one logical address not meeting the preset condition after the reading operation corresponding to the selected logical addresses is completed.

23. The memory storage device according to claim 21, wherein the logical addresses further comprise at least one logical address not meeting the preset condition, wherein the operation of executing the at least one reading operation corresponding to the logical addresses according to the reading order by the memory control circuit unit comprises:
executing at least one reading operation corresponding to the at least one logical address not meeting the preset condition according to the reading order, and executing the reading operation corresponding to the selected logical addresses after the at least one reading operation corresponding to the at least one logical address not meeting the preset condition is completed.

24. The memory storage device according to claim 19, wherein the physical programming units are classified into a first use area and a second use area, wherein a physical programming unit belonging to the first use area is programmed by a first programming mode, and a physical programming unit belonging to the second use area is programmed by a second programming mode,
wherein the preset condition further comprises that the first physical programming unit and the second physical programming unit belong to a same use area.

25. The memory storage device according to claim 24, wherein the first programming mode is a single level cell programming mode, and the second programming mode is a trinary level cell programming mode.

26. The memory storage device according to claim 19, wherein each plane among the planes comprises a plurality of physical erasing units, and each physical erasing unit among the physical erasing units comprises a part of the physical programming units,
wherein the first physical programming unit belongs to a first physical erasing unit among the physical erasing units, and the second physical programming unit belongs to a second physical erasing unit among the physical erasing units, wherein the first address index value is configured to indicate an address offset of a starting address of the first physical programming unit relative to a start address of the first physical erasing unit, and the second address index value is configured to indicate an address offset of a starting address of the second physical programming unit relative to a start address of the second physical erasing unit.

27. The memory storage device according to claim 19, wherein the operation of executing the reading operation corresponding to the selected logical addresses by the memory control circuit unit for reading the data belonging to the selected logical addresses in parallel comprises:
sending an address command, wherein the address command includes only a row address corresponding to the first physical programming unit and a row address corresponding to the second physical programming unit, or includes only a column address corresponding to the first physical programming unit and a column address corresponding to the second physical programming unit; and
sending a read action command for reading data stored in the first physical programming unit and the second physical programming unit in parallel according to the address command.
